(19) United States
(12) Patent Application Publication
(10) Pub. No.: US 2023/0372943 A1
(43) Pub. Date: Nov. 23, 2023

(54) MODULAR AND RAPID REAL-TIME PCR DEVICE

(71) Applicants: BAHCESEHIR UNIVERSITESI, Istanbul (TR); MARMARA UNIVERSITESI REKTORLUGU OZEL KALEM BIRIMI, Istanbul (TR)

(72) Inventors: Mehmet Can ALPHAN, Istanbul (TR); Ibrahim Ertugrul YALCIN, Istanbul (TR); Lutfi ARDA, Istanbul (TR); Ibrahim Ilker OZYIGIT, Istanbul (TR)

(73) Assignees: BAHCESEHIR UNIVERSITESI, Istanbul (TR); MARMARA UNIVERSITESI REKTORLUGU OZEL KALEM BIRIMI, Istanbul (TR)

(21) Appl. No.: 18/029,119

(22) PCT Filed: Sep. 27, 2021
(86) PCT No.: PCT/TR2021/050984

§ 371 Date: Mar. 29, 2023

(30) Foreign Application Priority Data
Sep. 30, 2020 (TR) 2020/15580
Mar. 25, 2021 (TR) 2021/005429

(51) Int. Cl. B01L 7/00

(52) U.S. Cl. CPC B01L 7/52; B01L 2300/18; B01L 2300/0829

(57) ABSTRACT

A real-time PCR device having a heating mechanism (10) for providing heating of samples and realizing measurement in the heated samples in order to subject the samples to denaturation, annealing and extension processes. The real-time PCR device has a heating unit carrier (100) having at least one first heating unit (111) which provides heating of a first heating region (131) at a first temperature for the denaturation process, at least one second heating unit (112) which provides heating of a second heating region (132) at a second temperature for the annealing process, at least one third heating unit (113) which provides heating of a third heating region (133) at a third temperature for the extension process, a measurement unit (114) for stimulating samples by sending light to a measurement region (134) and for measuring the light emitted by the samples in correspondence with the sent light for the measurement process.

### TECHNICAL FIELD

The present invention relates to a new design for providing amplification in shorter time when compared with real-time PCR devices used presently and for using the device in different equipment thanks to the modular structure thereof, in order to provide subjecting of samples to denaturation, annealing and extension processes in real-time PCR (polymerase chain reaction) devices and heating of samples and applying of light to samples which become ready for measurement and measuring of light intensity emitted by samples where light has been applied.

### PRIOR ART

Studies in the field of molecular biology and bio-engineering are rapidly increasing worldwide. In molecular biology studies, amplifying of the specific DNA and RNA parts by isolation and presence of specific gene parts in the target living being and the detection of the amount are among the most important components of these studies. In these studies, PCR (polymerase chain reaction) device is frequently used. PCR is based on amplifying the genetic material by means of chemical methods upon amplifying and measuring of targeted DNA region (mostly genes). In amplifying of the desired gene part, the target gene part is copied by a very repetitive reaction with the help of Tag DNA polymerase enzyme and bases added to the medium. Thanks to purified DNA polymerases and chemically extended DNA oligo-nucleotides, it is possible that a specially determined DNA array is copied without needing a rapid and living cell. This technique is called “polymerase chain reaction (PCR)”. Thanks to this technique, that DNA part is copied billions of times in an in vitro manner without knowing all of the genome and without needing host cell and only by knowing the desired DNA array. The polymerase chain reaction (PCR) is an in vitro and in vivo DNA amplification method, and the reactions are based on repeating three events, which are at different temperatures, in the form of cycles. DNA parts can be amplified with PCR, and sufficient amount can be obtained for sequencing and similar analyses from the samples in nano-gram amount.

PCR is essentially formed by the repetitions of three main cycles: (1) Denaturation, separating of the DNA with double strand to two single strands at 94° C., (2) annealing, binding of primers specifically to the mold DNA in the form of strand at 50-60° C. and (3) extension, amplification of the region, delimited by primers, by Tag DNA polymerase at 72° C. The real-time PCR comprises a measurement step additionally. When samples prepared by means of different dye substances and tags come to the measurement position, they are stimulated by means of light at suitable wavelength, and correspondingly, the emission intensity of the light emitted by the samples is measured.

As a result of repetition of these three steps many times, the targeted DNA part is copied at desired amounts and measurements thereof are realized. The devices, which exist already in the market, provide copying of the genetic material by means of repeating the reaction by realizing heating and cooling processes with the help of thermo-electric elements.

Samples are placed to the devices known in the present art, and heating, cooling and measurement processes are realized respectively as needed. The cooling process and the heating process for reaching the desired temperature lead to long-lasting of the PCR processes.

In order to realize the exact diagnosis of viral diseases like Covid-19, the genetic material of the virus which leads to the disease is copied in the samples taken from the body of the person who is being tested, and is brought to amounts which can be detected, and PCR method is frequently used in making the detection and in exact realization of the diagnosis and is accepted as the most reliable diagnosis method. However, since the detection of the target genetic material lasts long by realizing sufficient copying and since the sampling capacities of presently used devices are low, usage of alternative systems like fast test kits, which have low accuracy ratios but which can give more rapid result, is needed.

As a result, because of the abovementioned problems, an improvement is required in the related technical field.

### BRIEF DESCRIPTION OF THE INVENTION

The present invention relates to a new real-time PCR device which provides heating of the samples and which provides amplification in short time when compared with the presently used systems and which provides usage of the device with different equipment thanks to the modular structure thereof, for eliminating the abovementioned disadvantages and for bringing new advantages to the related technical field.

An object of the present invention is to provide an alternative system which provides subjecting of the samples to process in an accelerated manner.

Another object of the present invention is to provide an alternative system for real-time PCR device which will provide simultaneous subjecting of the samples, which are higher in number when compared with the presently used devices, to processes.

In order to realize the abovementioned objects and the objects which are to be deducted from the detailed description below, the present invention is a real-time PCR device comprising a heating mechanism for providing heating of samples and realizing measurement in the heated samples in order to subject the samples to denaturation, annealing and extension processes. Accordingly, the improvement of the present invention is that the subject matter PCR device comprises a heating unit carrier comprising at least one first heating unit which provides heating of a first heating region at a first temperature for the denaturation process, at least one second heating unit which provides heating of a second heating region at a second temperature for the annealing process, at least one third heating unit which provides heating of a third heating region at a third temperature for the extension process, a measurement unit for stimulating samples by sending light to a measurement region and for measuring the light emitted by the samples in correspondence with the sent light for the measurement process, wherein said first heating unit, said second heating unit, said third heating unit and said measurement unit are arranged in a first circular axis; the subject matter PCR device comprises a sample carrier comprising at least one sample chamber placed in at least one point at a second circular axis which is parallel to said first circular axis; subject matter PCR device further comprises at least one movement mechanism which provides movement of the sample chamber in a manner providing passage of the sample chamber between said first heating region, said second heating region, said third heating region and said measurement region. Thus, by using different heating units for different processes, the need for waiting for cooling and heating is avoided, and the process is accelerated.

In a possible embodiment of the present invention, said heating unit carrier further comprises a measurement unit provided in said first circular axis and which defines a measurement region. Thanks to this structure, samples with increased number when compared with the present art are heated.

In another possible embodiment of the present invention, the heating units comprise a first heating element and a second heating element positioned mutually in a manner defining a heating region in between.

In another possible embodiment of the present invention, said sample carrier is in plate form, and the heating unit carrier is in the form of a plate placed in a parallel manner to the sample carrier, and the movement mechanism is configured to move the sample carrier and/or heating unit carrier in an axis passing through the center of the sample carrier and/or heating unit carrier.

In another possible embodiment of the present invention, said sample carrier is in cylindrical form, and said heating unit carrier is configured to telescopically engage with the sample carrier, and the movement mechanism is configured to move the sample carrier and/or heating unit carrier in an axis passing through the center of the sample carrier and/or heating unit carrier.

In another possible embodiment of the present invention, said sample carrier is in hexagonal or octagonal prism form, and said heating unit carrier is in the form of a prism configured to telescopically engage with the sample carrier, and the movement mechanism is configured to move the sample carrier and/or heating unit carrier in an axis passing through the center of the sample carrier and/or heating unit carrier.

In another possible embodiment of the present invention, the sample carrier comprises pluralities of sample chambers positioned in said second circular axis.

In another possible embodiment of the present invention, the sample carrier comprises sample chambers provided in the same number as the total number of measurement units and as the number of the heating units positioned in said second circular axis.

In another possible embodiment of the present invention, the sample chambers are arranged in a manner annealing with the radian between the radian sequential heating units between the sequentially arranged sample chambers and the measurement unit.

DNA parts can be amplified with PCR and the sufficient amount is obtained for sequencing and similar analyses from the samples in nano-gram amount. Normally, in real-time PCR methods, long amplification duration is needed for obtaining desired amount of DNA. This situation is a disadvantage for obtaining high amount of genetic material. The amount of genetic material to be obtained in short-duration cycles stays at very low amounts. However, by means of the speed advantage which will be presented by the designed system/device, the desired genetic material can be obtained in a very rapid manner and in very high amounts. Moreover, much more amount of samples can be amplified when compared with real-time PCR devices used presently.

### BRIEF DESCRIPTION OF THE FIGURES

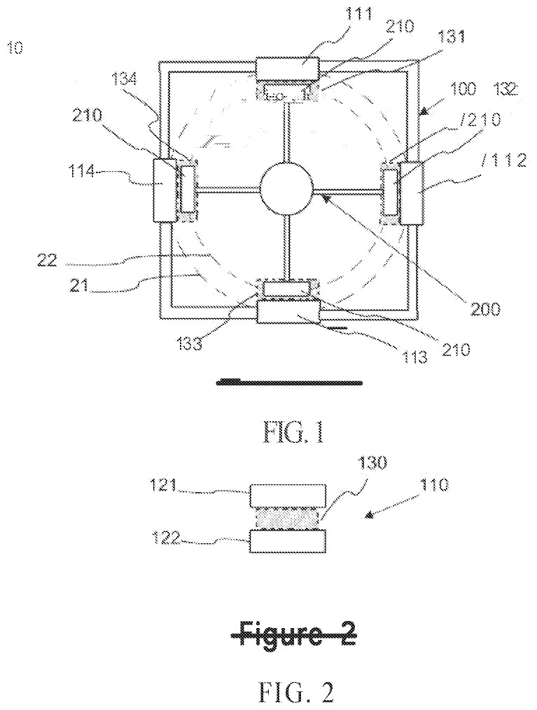

In FIG. 1, a view of an embodiment of the heating mechanism of the real-time PCR device is given.

In FIG. 2, a representative cross-sectional view of an embodiment of one of the heating unit is given.

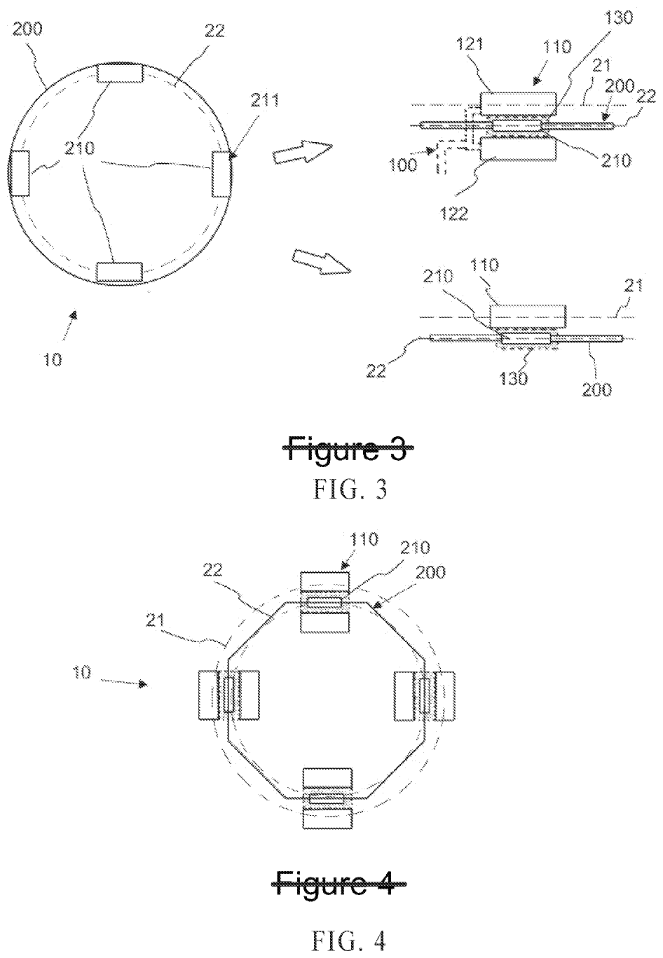

In FIG. 3, a top representative view of the embodiment where the sample carrier is in plate form and a lateral cross-sectional view where said embodiment comprises heating elements and a lateral cross-sectional view where said embodiment comprises the first heating element and the second heating element of the heating unit are given.

In FIG. 4, a top representative view of the embodiment where the sample carrier is in octagonal prism form is given.

### DETAILED DESCRIPTION OF THE INVENTION

In this detailed description, the subject matter is explained with references to examples without forming any restrictive effect only in order to make the subject more understandable.

The present invention is a modular heating mechanism (10) which provides the placed samples to be subjected to denaturation, annealing, extension processes and which provides sending of light to the samples which are subjected to these processes and which provides measurement of the emission intensity of the light emitted by said samples as a reaction to the sent light, and a real-time PCR device comprising said heating mechanism (10). It essentially provides movement in a circular axis between the heating regions where the heaters, which provide realization of the denaturation, annealing, extension and measurement processes of samples, provide heating, and the measurement region where the measurement device (photoluminescence—PL) makes measurement.

With reference to FIG. 1, the present invention comprises a heating unit carrier (100) and a sample carrier (200). The sample carrier (200) and the heating unit carrier (100) move relatively with respect to each other and provide passage of the sample chambers (210) in the sample carrier (200) between the heating units (110) and the measurement unit (114) in the heating unit carrier (100) and provides subjecting to the denaturation, annealing and extension processes. In FIG. 1, the representative view of the heating unit carrier and the sample carrier is given. The sample carrier and the heating unit carrier can have any form which can realize the movement which will be defined below.

In more details, the heating unit carrier (100) comprises a first heating unit (111), a second heating unit (112), a third heating unit (113) and a measurement unit (114) arranged in a first axis. In a possible embodiment of the present invention, the heating unit carrier (100) further comprises a holding unit (not shown in the figures). The heating units (110) emit heat for providing subjecting of the samples to denaturation, annealing and extension processes. As known well in the art, the measurement unit (114) sends light at suitable wavelength and stimulates the samples prepared by means of different dye substances and tags when said samples come to a measurement region (134), and measures the emission intensity of the light emitted by the samples stimulated by means of light. The holding unit provides waiting of the samples in a holding region. The first heating unit (111) realizes heating in a manner keeping a first heating region (131) at a first temperature. The second heating unit (112) realizes heating in a manner keeping a second heating region (132) at a second temperature. The third heating unit (113) realizes heating in a manner keeping a third heating region (133) at a third temperature. The heating units (110) can be associated with components like sensors, processors, etc. which control operation. The measurement unit (114) can comprise light emitters for sending light to the samples, and sensors (photodiodes, etc.) for measuring the intensity of the light emitted by the samples stimulated by means of light. Since the details of the heating units and the measurement unit in real-time PCR devices are well known in the art, these details have not been given here.

The first temperature can be 94 degrees centigrade which is needed for denaturation, and the second temperature can be 50-60 degrees centigrade which is needed for annealing, and the third temperature can be 72 degrees centigrade which is needed for extension.

In a possible embodiment of the present invention, the heating units (110) can comprise a first heating element (121) and a second heating element (122) positioned in a manner defining a heating region in between.

The sample chambers (210) describe the mechanisms where the samples to be processed are placed in real-time PCR device. There is at least one sample chamber (210) in a manner positioned in a second circular axis (22) which is parallel to the first circular axis (21) on the sample carrier (200).

A movement mechanism (not shown in the figures) provides movement of the heating unit carrier (100) and/or sample carrier (200) in a manner visiting of a first heating region (131), a second heating region (132), a third heating region (133) and a measurement region (134) by the sample chamber (210). The movement mechanism can comprise drive elements like motor and can be controlled by drivers.

In a possible embodiment of the present invention, the sample carrier (200) comprises four sample chambers (210). In a possible embodiment, the sample carrier (200) also comprises a holding chamber (not illustrated in the figures) provided for waiting. Said sample chambers (210) are arranged in the second circular axis (22) and are arranged at radians between the heating units (110) and the measurement region (114). For instance, the heating units (110) and the measurement unit (114) can be arranged at 90 degrees/pi radian intervals. In other words, the center angle through the center of the first circular axis (21) between two sequential units is 90 degrees. In other words, three heating units and a measurement unit are placed to the first circular axis (21) with equal intervals. In this case, the sample chambers (210) are arranged through the center of the second axis such that the center angles in between are 90 degrees, in other words, such that the center angles in between are 90 degrees/pi radians. While a sample chamber (210) is in a heating region (130), all other sample chambers (210) are positioned in the remaining heating regions (130) and one is positioned in the measurement region (134). Thus, the four samples are subjected to denaturation, annealing, extension and measurement processes simultaneously by using only three heating units (110) and a measurement unit (114).

With reference to FIG. 3, the sample carrier (200) is provided in plate form, preferably in circular plate form. The sample carrier (200) can realize its movement by rotating in an axis which passes through the center thereof and which is orthogonal to the plane where the plate extends. In this possible embodiment, the heating unit carrier (100) can also be in plate form and can be positioned in a parallel manner to the sample carrier (200). In this possible embodiment, the heating unit carrier (100) can comprise two bodies in plate form in a manner facing two faces of the sample carrier (200), and the first heating element (121) and the second heating element (122) of the heating units (110) can be positioned at these plates. In the form seen from above, only the sample carrier (200) has been given, and the heating unit carrier and the axes have also been shown in a representative manner in the lateral views.

With reference to FIG. 4, in a possible embodiment of the present invention, the sample carrier (200) can be in cylindrical or octagonal prism or hexagonal prism form. The heating unit carrier (100) can be provided in a manner telescopically engaging with the sample carrier (200). One of the heating unit carrier (100) or the sample carrier (200) can rotate at an axis which passes through the centers thereof. In this manner, only the representative view of the sample carrier (200) is given and the heating unit carrier (100) can be configured in a fixed or movable manner in a compliant manner.

The operation of the present invention whose details are given above can be realized as follows. A sample is placed to one of the sample chambers (210). The sample carrier (200) or the heating unit carrier (100) is moved such that the sample arrives at the first heating region (131). After a predetermined duration, the sample is placed to the sample chamber (210) which is positioned after the full sample chamber (210), and the heating unit carrier (100) or the sample carrier (200) is moved such that the recently filled sample chamber (210) comes to the first heating region (131). In this arrangement, the other chambers are respectively filled, and when the firstly filled sample chamber (210) exits the third heating unit (113), said firstly filled sample chamber (210) can come to the measurement region (134) and afterwards come to the first heating region (111) again, and the cycle can be repeated at a desired number of times.

One of the sample carrier (200) and the heating unit carrier (100) can be movable and other one can be fixed. While the movable one can have a body formed by cylindrical plate or arms, and the other one can be fixed to the body of the real-time PCR device by means of various arms.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Heating mechanism
100 Heating unit carrier
110 Heating unit
111 First heating unit
112 Second heating unit
113 Third heating unit
114 Measurement unit
121 First heating element
122 Second heating element
130 Heating region
131 First heating region
132 Second heating region
133 Third heating region
134 Measurement region
200 Sample carrier
210 Sample chamber
21 First circular axis
22 Second circular axis

What is claimed is:

1. A real-time PCR device comprising a heating mechanism for providing heating of samples and measuring heated samples and subjecting the samples to denaturation, annealing and extension processes, wherein the real-time PCR device comprises:
a heating unit carrier comprising at least one first heating unit which provides heating of a first heating region at a first temperature for the denaturation process,
at least one second heating unit which provides heating of a second heating region at a second temperature for the annealing process,
at least one third heating unit which provides heating of a third heating region at a third temperature for the extension process,
a measurement unit for stimulating samples by sending light to a measurement region and for measuring the light emitted by the samples in correspondence with a sent light for the measurement process,
wherein said first heating unit, said second heating unit, said third heating unit and said measurement unit are arranged in a first circular axis;
and the real-time PCR device further comprises a sample carrier comprising at least one sample chamber placed in at least one point at a second circular axis which is parallel to said first circular axis;
and the real-time PCR device further comprises at least one movement mechanism which provides movement of the sample chamber in a manner between said first heating region, said second heating region, said third heating region and said measurement region.

2. The real-time PCR device according to claim 1, wherein said heating unit carrier further comprises a holding unit provided in said first circular axis and which defines a holding region.

3. The real-time PCR device according to claim 1, wherein a plurality of heating units comprise a first heating element and a second heating element positioned to define a heating region in between said first heating element and said second heating element.

4. The real-time PCR device according to claim 1, wherein said sample carrier is in a plate form, and the heating unit carrier is in the plate form and placed in a parallel manner to the sample carrier, and the movement mechanism is configured to move the sample carrier and/or heating unit carrier in an axis passing through the center of the sample carrier and/or heating unit carrier.

5. The real-time PCR device according to claim 1, wherein said sample carrier is in cylindrical form, and said heating unit carrier is configured to telescopically engage with the sample carrier, and the movement mechanism is configured to move the sample carrier and/or heating unit carrier in an axis passing through the center of the sample carrier and/or heating unit carrier.

6. The real-time PCR device according to claim 1, wherein said sample carrier is in hexagonal or octagonal prism form, and said heating unit carrier is in the form of a prism configured to telescopically engage with the sample carrier, and the movement mechanism is configured to move the sample carrier and/or heating unit carrier in an axis passing through the center of the sample carrier and/or heating unit carrier.

7. The real-time PCR device according to claim 1, wherein the sample carrier comprises a plurality of sample chambers positioned in said second circular axis.

8. The real-time PCR device according to claim 6, wherein the sample carrier comprises a plurality of sample chambers provided in the same number as the total number of measurement units and as the number of the heating units positioned in said second circular axis.

9. The real-time PCR device according to claim 6, wherein a plurality of sample chambers are arranged in a manner annealing with the radian between the radian sequential heating units between the sequentially arranged sample chambers and the measurement unit.

10. The real-time PCR device according to claim 7, wherein the plurality of sample chambers are arranged in a manner annealing with the radian between the radian sequential heating units between the sequentially arranged sample chambers and the measurement unit
